(19) United States
(12) Patent Application Publication
(10) Pub. No.: US 2012/0137102 A1
(43) Pub. Date: May 31, 2012

(54) CONSUMER APPROACH BASED MEMORY BUFFER OPTIMIZATION FOR MULTIMEDIA APPLICATIONS

(76) Inventors: Ramkumar PERUMANAM, Carmel, IN (US); Jens Cahnbley, Princeton Junction, NJ (US); Ishan Uday Mandrekar, Monmouth Junction, NJ (US)

(21) Appl. No.: 13/294,216

(22) Filed: Nov. 11, 2011

Related U.S. Application Data
(60) Provisional application No. 61/458,691, filed on Nov. 30, 2010.

(51) Int. Cl. G06F 12/02

(52) U.S. Cl. 711/170

(57) ABSTRACT

A multimedia storage method is provided in which the memory allocations to applications are just the sufficient or right amount and do not over allocate or waste memory resources, thereby ensuring that other applications that need memory can operate properly and efficiently.

### CROSS-REFERENCE TO RELATED APPLICATION

This application claims priority from U.S. Provisional Application 61/458,691 filed Nov. 30, 2010 which is incorporated by reference herein in its entirety.

### FIELD OF THE INVENTION

The invention is related to multimedia applications requiring buffering of data.

### BACKGROUND OF THE INVENTION

Multimedia applications typically perform various computing tasks on the multimedia data before the data could be displayed on a display device to the user. These applications use data buffers allocated on the system memory to store and process the media data and typically require sufficient amount of memory to store these buffers. Most of the current day computing systems have many applications that coexist on the same system and run at the same time sharing the common system resources such as memory, central processing unit (CPU), etc.

FIGS. 1 and 3 show pictorial representations of known producer based approaches for buffering data. Such data can include streaming video/audio data.

FIG. 1 shows a simple producer based memory allocation scheme in which the producer block 110 represents a file reader that reads multimedia content from a file supplied by the producer. An example of this is MP4 file reader; however, various other or receiver receives multimedia data using some network protocol. One example is a Real-time Transport Protocol (RTP) receiver that receives multicast or unicast data streams from a streaming server. FIG. 1 further shows buffer pools. The producer buffer pool block 130 corresponds to the media data read from a file of the producer to be allocated on the computer memory, wherein the data would be stored in buffer pools or a set of buffers and would be accessible to the particular multimedia application being used. The consumer buffer pool block 140 corresponds to the buffer pools or the set of buffers of the media data actually received and stored in memory regions from the network interface. FIG. 1 shows consumer block 120 which corresponds to processed media data that will be used by an application on the consumer device. For example, a video player application will display or play the video/audio to the user on the user's display. The user will perform actions such as pause, rewind, pause etc. to control the video/audio, for example. The video memory block 150 represents the processed video from the buffer pools or the set of buffers copied into the Video RAM (Random Access Memory) or the memory on a graphics card before being rendered or displayed onto the user's display.

FIG. 3 shows a layered data creation with producer memory allocation. In this figure, the producer block 310, consumer/producer 315, and the consumer block 320 each represent a stage in protocol processing order. The producer block 310 can be a packetizer such as an RTP packetizer that can break video/audio data into packets of a particular size to be streamed. The consumer/producer block 315 can be a packet creator such as a User Datagram Protocol (UDP) packet creator for multicasting or unicasting of the packets. The consumer block 320 can be a packet creator such as an Internet Protocol (IP) packet creator. Each of these blocks adds a stage or layer specific protocol header to the data obtained from its producer and hands it over to consumer along the next stage of processing. The producer buffer block 330 represents the buffer that holds data prepared by packetizer in producer block 310 and consumer/producer buffer block 340 represents the buffer of the data received by the packet creator in the consumer/produce block 315, wherein the data and/or the buffer can be identical when buffer memory address is exchanged or shared between the producer block 310 and consumer/producer blocks 315. The consumer/producer 315 then creates a protocol header 350 and a new buffer 360 from consumer/producer buffer block 340. This new buffer 360 is created by allocating a bigger buffer to hold the received buffer in the consumer/producer buffer block 340 and the associated header or protocol header 350 to be added. The packet creator in consumer/producer blocks 315 copies the received buffer and prepends a layer or stage specific header and passes it on to the consumer block 320. FIG. 3 further shows the protocol header 350 and the new buffer 360 from consumer/producer buffer block 340 being transferred to or shared with the consumer block 320 to become header portion 365 and buffer portion 370, wherein the protocol header 350 and header portion 365 are identical and the new buffer 360 and buffer portion 370 can be identical if the buffer is exchanged between consumer/producer 315 and the consumer block 320 via memory address sharing. At the consumer block 320, a bigger buffer is allocated to hold another protocol header 375, an existing header data 380, and the resultant buffer 385. In other words, at the consumer block 320 stage, the consumer's device copies the received buffer and prepends a layer/stage specific header (i.e., another protocol header 375) before transmitting the new buffer to the network. In sum, the header data in protocol header 350, header portion 365, and existing header data 380 can be the same and the buffer content in new buffer 360 and buffer portion 370 can be the same.

Because these known producer based memory allocation approaches may undesirably create excessive memory copies that could potentially slow down the performance of the desired applications, it would be beneficial to utilize improved memory allocation processes. As such, it would be beneficial to develop memory allocation processes in which the memory allocations to applications are just the sufficient or right amount and do not over allocate or waste the memory resources, thereby ensuring other applications that need memory can operate properly or more efficiently.

### SUMMARY OF THE INVENTION

A consumer or consumption approach based model of memory buffer allocation is disclosed that optimizes the memory buffers allocated to multimedia applications resulting in better use of system resources as well as reducing the computationally expensive operation of memory buffer copy, thereby leading to improved performance of multimedia applications.

One embodiment involve a method of accessing and storing multiple media data segments from a producing device on to a consumer device that can involves allocating a portion of memory buffer on a consumer device for receiving the multiple media data segments, wherein the allocation of the portion is performed responsive to the nature of the multiple media data segments in which the multiple media segments can be read from a file reader and the multiple media segments can be MP4, AV1 or MP3 multimedia file formats. The method can further include the steps of accessing a first segment of the multiple media data segments for writing; verifying a status of the portion of memory buffer as being available to receive the first segment or not being available to receive the first segment; writing the first segment to the portion when the portion is available; storing the first segment on the consumer device; removing the first segment from the portion; and repeating the allocating, accessing, verifying, writing, and storing steps for other segments, one by one. Additional steps can include receiving the multiple media data segments by the consumer device employing a network protocol, creating the portion of the memory buffer from a memory pool of graphics card internal memory; and/or having the consumer device communicate the input data rate required by the consumer device to receive the multimedia data segments. The method can also include the step of limiting the portion of memory buffer such that the portion has a fixed size that is limited to a necessary and sufficient quantity, thereby other portions of the memory buffer are free for other applications.

An aspect of the invention can involve a system in which at least one producing device provides multiple media data segments to a consumer device that employs the steps of allocating specific memory buffers on the consumer device for receiving the multiple media data segments, wherein the allocation of the specific memory buffers is performed responsive to the nature of multiple media data segments; accessing a first segment of the multiple media data segments for writing; verifying a status of the specific memory buffers as being available to receive the first segment or not available to receive the first segment; writing the first segment to the specific memory buffers when the specific memory buffers are available; storing the first segment on the consumer device, wherein the first segment can be subsequently removed from the portion; and repeating the steps for other segments, one by one. The system can be adapted to include the steps of limiting the specific memory buffers to fixed sizes which are sufficient to permit other portions of memory on the consumer device to be free for other applications.

An additional aspect of the invention for cases that involve accessing and storing multiple stages of media data from at least one producing device on to a consumer device can comprise the steps of accessing a header for each of the stages; allocating specific memory buffers on the consumer device for receiving the multiple stages data, wherein the specific memory buffers have a fixed size that is large enough to store all the headers and a user provided payload buffer; separately accessing each stage for writing; verifying a status of the specific memory buffers as being available to receive the given stage or not available to receive the given stage; writing the given stage to the specific memory buffers when the specific memory buffers are available; storing the given segment on the consumer device; and removing the given segment from the specific memory buffers and freeing the specific memory buffers for a next stage to be processed in the verifying, writing and storing steps. The consumer and/or producer devices can be further adapted such that specific memory buffers can be limited to a necessary and sufficient quantity or quantities such that other portions of memory on the consuming device are free for other applications. Further steps can include creating the specific memory buffers from a memory pool of graphics card internal memory, wherein the specific memory buffers can be created according to stacked network protocols and can also be created such that each protocol is implemented as a stage that requires adding its own header to the memory block containing user provided payload. At least one stage can use an RTP protocol and an RTP protocol header can be added in front of at least one user provided payload. Additionally, multiple producers can be accessed and the consumer device can be adapted to permit the producers to just fill in their header portion.

### BRIEF DESCRIPTION OF THE DRAWINGS

The invention will now be described by way of example with reference to the accompanying figures which are as follows:

FIG. 1 shows a producer based memory allocation scheme according the prior art;

FIG. 2 shows a consumer based memory allocation scheme according the invention;

FIG. 3 shows a layered data creation scheme employing a producer based memory allocation protocol according the prior art;

FIG. 4 shows a layered data creation scheme employing a consumer based memory allocation protocol according the invention;

FIG. 5 shows a flowchart according to the invention of a consumer based memory allocation scheme; and

FIG. 6 shows a flowchart according to the invention of a consumer based memory allocation scheme in which at least one producing device provides multiple stages of data to a consumer device.

### DETAILED DESCRIPTION OF THE EMBODIMENTS

To address the issue of optimal allocation of memory, a consumption approach based model of memory buffer allocation is disclosed that optimizes the memory buffers allocated to multimedia applications resulting in better use of system resources as well as reducing the computationally expensive operation of memory buffer copy, thereby leading to improved performance of multimedia applications. The memory buffers are allocated at the consumer of a particular type of data. Thus, the uncompressed media buffers can be created out of the memory pool of the graphics. Using this approach, only the necessary and sufficient quantity of data buffers are allocated to the multimedia applications, thereby freeing up a greater quantity of system memory resources to be used by other applications that are in need of such resources.

In a typical multimedia application such as a media player that plays a compressed media files stored on a storage medium, the processing steps include reading portions of file into memory buffers, uncompressing the media data and then displaying it on a display device. During each of the steps above, memory buffers are used to hold the input data and the output data resulting from the processing such as compressed data and uncompressed data. As the data gets processed from input format to the data suitable for display, memory buffers are handed over from one computing task to next. Also, in case a computing task uses its own private memory such as the graphics display device, memory buffer from previous stage of computation has to be copied into the next stage's memory buffer region. In such a system as the file is being played continuously, many memory copies result since the buffers are allocated by the producer or the originator of the data. In addition, as the display memory is considerably less than the overall system memory the previous processing stages may allocate more buffers than needed and hold them in a manner that would in no way help the performance of the application at the same time depriving other applications running on the same system of memory.

However, by having a consumer model of memory buffer approach where instead of allocating memory at the source or the producer of data, memory buffers are provided by the consumer, memory buffer copies are minimized and producers do not over allocate idle buffers and work at the rate consumers operate.

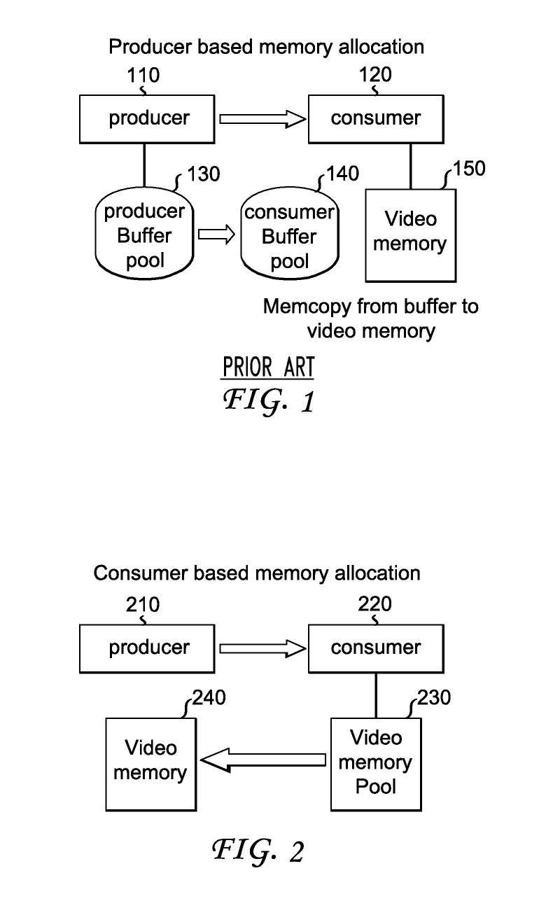

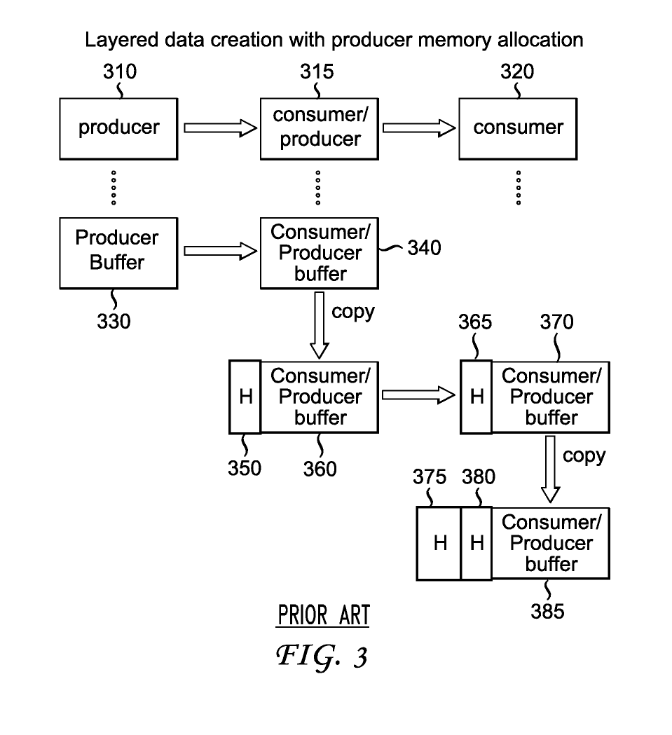

FIG. 2 shows the concept of the consumer model of the memory buffer approach. In FIG. 2, the producer block 210 represents a file reader that reads multimedia content from a file supplied by the producer. An example of this is MP4 file reader; however, various other multimedia file formats such as AV1, MP3, etc. exist and are applicable. Here, a network client or receiver receives multimedia data using some network protocol. One example can be a Real-time Transport Protocol (RTP) receiver that receives multicast or unicast data streams from a streaming server. Unlike FIG. 1, there is no producer buffer pool block 130 corresponding to the media data read from a file of the producer to be allocated on the computer memory, wherein the data would be stored in buffer pools or a set of buffers and would be accessible to the particular multimedia application being used. FIG. 2 shows consumer block 220 which corresponds to media data that will be used by an application on the consumer device. In consumer block 220, the consumer device will create out of the memory pool of the graphics device in the video memory pool block 230 uncompressed media buffers and write these uncompressed media buffers into in the video memory of the graphics device in the graphic device video memory block 240, wherein the consumer indicates to the producer the input data rate required by the consumer device so that producer will regulate the output to meet the consumer device command. In this manner, memory copies are minimized and the producer or the data originator matches its output to the rate required by the consumer rather than non-deterministically producing more data than required for the transfer, thereby preventing wasted memory and/or incurring memory copy penalty or both.

For some applications, performance could be greatly increased by directly writing into the display memory rather than writing into the system memory and then copying into the graphics card's internal memory, because memory copies are computationally expensive.

In at least one multimedia application, a pipe-lined data flow model is used in which data flows from one computing/processing task to the next. For example, in a multimedia player application that could play media files containing compressed video or audio such as a MP4 file, the typical computational tasks include reading the media content from the file residing on a storage device in smaller chunks into memory, uncompressing or decoding the data that was read and finally rendering the uncompressed media data on a hardware device such as a display device for video media. If the same media player application is capable of playing media files obtained from a network, then it would include processing tasks of obtaining media data over the network using suitable networking protocols in place of reading the file from a storage device. As evident from the previously mentioned processing tasks, in these applications the data flows in a pipe-lined fashion from one stage to another. The data flow between the stages or computational tasks in such a system is accomplished by means of allocating data buffers that are shared among the stages within the application. To illustrate, one of the stages such as reading from a file creates or produces the data buffers that are subsequently consumed by another stage such as a decoder which is part of the data pipeline. Since the data entering a stage as input might leave the stage unaltered or might get transformed during the processing at a stage, the data buffers of various kinds are needed to accomplish the overall goal of the application. In addition, it may also be possible that some of the stages have their own physical memory to store working memory buffers in which case the data from previous stage has to be copied into these local memory buffers. This is true in case of a graphics display device which uses its own memory to store the data to be displayed. Since the multimedia content is large in size as well as has to be played for a longer duration, the memory buffer requirements for such applications are quite large and possibly involve lots of memory copies between buffers if some of the stages have local memory. This is undesirable since the memory copies could potentially slow down the performance of the application. Also in case of the buffer allocation based on producer model in which the stages that are data producers allocate memory buffers, it is difficult to allocate the exact amount of buffers needed ahead of time since buffer consumption rate may not be known. In these situations, if a producer is producing or filling up buffers at a rate greater than the rate consumed, it would hold up the memory without any use and also prevent any other applications running on the system that are short on the memory. To alleviate these problems a consumer centric memory buffer allocation model is proposed.

In this approach, the memory buffers are allocated at the consumer of a particular type of data. Thus, the uncompressed media buffers are created out of the memory pool of the graphics device. The prior stage when it needs to output a data buffer to its next stage queries the next stage for a memory buffer. In case a memory buffer is available the data will be directly written into the consumer buffer. Otherwise the prior stage will wait until a buffer becomes available. With such an approach the memory copies are minimized and the producer or the data originator matches its output to the rate required by the consumer, rather than non-deterministically producing more data than required, thereby resulting either in wasted memory or incurring memory copy penalty or both of these inefficiencies.

The minimization of memory copies using this approach over the producer based allocation scheme could be illustrated using applications that create data buffers using layered approach. An example for such an application is stacked network protocols. In this application each protocol implemented as a stage requires adding its own header to the memory block containing user provided payload. For example, a RTP packetizer stage that prepares packets to be sent using RTP protocol would need to add the RTP protocol header in front of the user payload. Therefore, this stage would need to allocate a bigger buffer that would hold the header and user payload and then store the header and copy the payload from the payload buffer. RTP protocol over IP normally uses UDP or TCP transport for transmitting packets on IP network. If the prepared RTP packet from RTP packetizer is then handed over to an UDP stage, then this protocol will need to add another header by the same means which requires yet another memory buffer allocation and buffer copy. Based on the number of protocol layers the application implements, the number of buffer allocations and memory copies will be significant if the each protocol stage allocates the data buffer and passes on to the next protocol stage. If the consumer based buffer allocation scheme is followed for the same application scenario, each receiving protocol or consumer stage will add the size of header header to the memory size requested by the producer or a previous stage and the final consumer or the stage that has no subsequent successors to it will allocate a single buffer that is large enough to store all the headers added by previous stages and the user provided payload buffer. Each of the producers will just fill in their header portion and the payload buffer will or need to be copied once into the single large buffer. Therefore, the consumer based memory allocation significantly reduces buffer allocation and memory copies in applications that involve layered data creation.

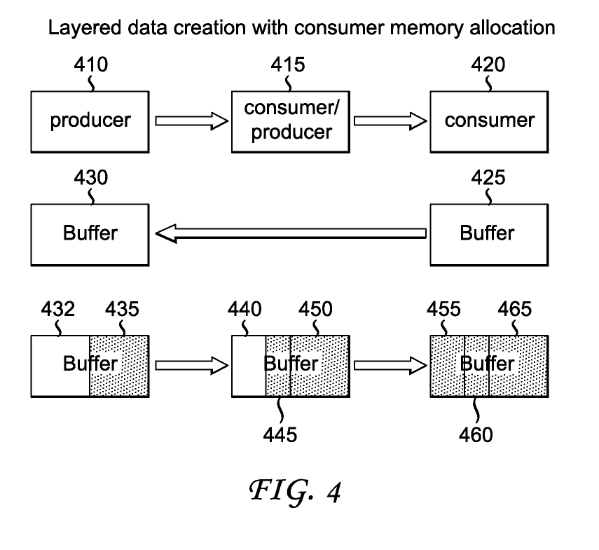

FIG. 4 illustrates the application the consumer based allocation scheme using the layered approach. An example for such an application is stacked network protocols. In this application each protocol implemented as a stage requires adding its own header to the memory block containing user provided payload. For example, a RTP packetizer stage that prepares packets to be sent using RTP protocol would need to add the RTP protocol header in front of the user payload. Therefore this stage would need to allocate a bigger buffer that would hold the header and user payload and then store the header and copy the payload from the payload buffer. RTP protocol over IP normally uses UDP or TCP transport for transmitting packets on IP network. If the prepared RTP packet from the RTP packetizer is then handed over to an UDP stage, then this protocol will need to add another header by the same means which requires yet another memory buffer allocation and buffer copy. Based on the number of protocol layers the application implements, the number of buffer allocations and memory copies will be significant if the each protocol stage allocates the data buffer and passes on to the next protocol stage. If the consumer based buffer allocation scheme is followed for the same application scenario, each receiving protocol or consumer stage will add the size of the its header to the memory size requested by the producer or a previous stage and the final consumer or the stage that has no subsequent successors to it will allocate a single buffer that is large enough to store all the headers added by previous stages and the user provided payload buffer. Each of the producers will just fill in their header portion and the payload buffer needed will be copied once into the single large buffer. Therefore the consumer based memory allocation significantly reduces buffer allocation and memory copies in applications that involve layered data creation.

More particularly, in FIG. 4, the producer block 410, consumer/producer 415, and the consumer block 420 each represent a stage in protocol processing order. The producer block 410 can be a packetizer such as an RTP packetizer which can break video/audio data into packets of a particular size to be streamed. The consumer/producer block 415 can be a packet creator such as a User Datagram Protocol (UDP) packet creator for multicasting or unicasting of the packets. The consumer block 420 can be a packet creator such as an Internet Protocol (IP) packet creator. The consumer will access data from the producer and allocate buffers in consumer buffer block 425 for the data and will pass information of the buffer allocation to entities representing the consumer/producer block 415 and producer block 410. If the memory address is shared between the producer block 410, consumer/producer block 415, and the consumer block 420, then entities representing the consumer/producer block 415 and producer block 410 will not be allocating new buffers or copying buffers. In this case where the memory address is shared, the consumer buffer blocks 425 and second consumer block 430 are shared and refer to same memory region. Once the buffers are allocated by consumer block 420, the producer block 410 will fill the portion of this buffer in buffer fill box 435 and generate and add first header 432 before first fill box 435. The producer block 410 then hands this portion or content over to consumer/producer box 415 and thus is placed in buffer fill box 450. The portions or contents of buffer fill box 435 and second buffer fill box 450 are the same. The consumer/producer block 415 will add second header 445 after carried over first header 440. The second header 445 is added before second buffer fill box 450. The consumer/producer block 415 then hands the second header 445 over to consumer block 420. The consumer block 420 next will add a third header 455 before second carried over header 460 and third buffer fill box 465 and before the buffer is made use of by processing of the layered data, wherein the buffered data in buffer fill boxes 435, 450 and 465 are the same and the second header 445 and second carried over header 460 are identical.

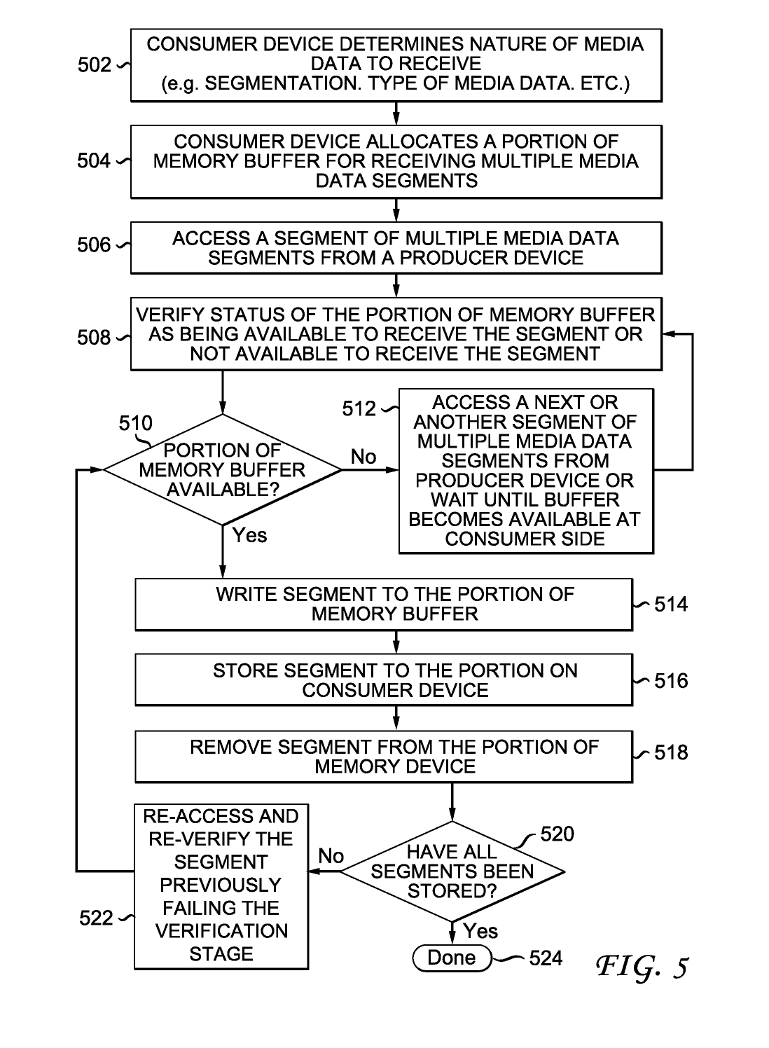

FIG. 5 is flowchart according to the invention of a consumer based memory allocation scheme highlighting a method that involves a system in which at least one producing device provides multiple media data segments to a consumer device. Here, the method comprises consumer device determining (502) the nature of the media data that is being received in terms of its segmentation and type. The method further comprises allocating (504) a portion of memory buffer on the consumer device for receiving the multiple media data segments. Here, the allocation of the portion is performed responsive to the nature of multiple media data segments such that the portion has a fixed size that is limited to a necessary and sufficient quantity such that other portions of the memory buffer are free for other applications. Additional steps include accessing (506) a first segment of the multiple media data segments for writing; verifying (508) a status of the portion of memory buffer as being available to receive the first segment or not available to receive the first segment; writing (514) the first segment to the portion when the portion is available; storing (516) the first segment on the consumer device, thereby removing (518) the first segment from the portion; and repeating steps 504, 506, 508, 514, and 516 for other segments, one by one. This involves employing decision block 510 to determine whether one should or needs to access a next or another segment of the multiple media data segments from the producer device. In block 512, a next or another segment of multiple media data segments from the producer device is accessed or the producer's device waits until a buffer becomes available at the consumer side to process the next segment. If all segments have not been stored per decision box 520, then a re-accessment and re-verification of the segments that may have previously failed the verification stage is performed.

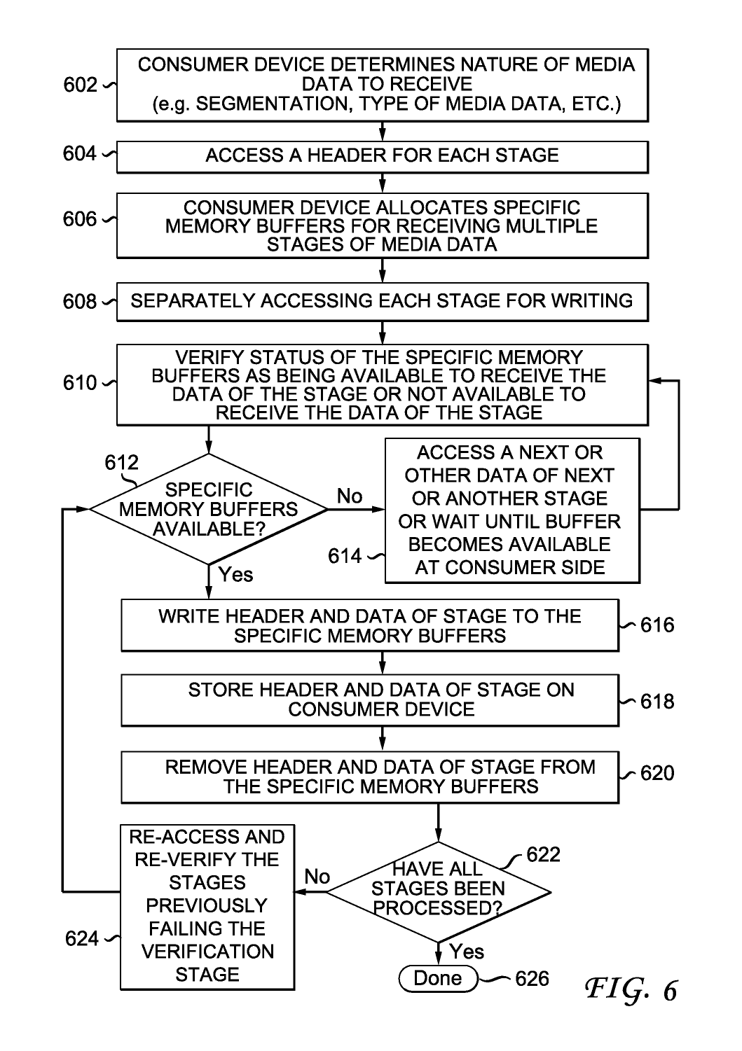

FIG. 6 shows a flowchart according to the invention of a consumer based memory allocation scheme in which at least one producing device provides multiple stages of data to a consumer device. Here, the method comprises consumer device determining (602) the nature of the media data that is being received in terms of its segmentation and type. The method comprises accessing (604) a header for each of the stages and allocating (606) specific memory buffers on the consumer device for receiving the multiple stages data such that the specific memory buffers have a fixed size that is large enough to store all the headers and a user provided payload buffer. Also, the specific memory buffers are limited to a necessary and sufficient quantity such that other portions of memory on the consuming device are free for other applications. The method further comprises separately accessing (608) each stage for writing and verifying (610) a status of the specific memory buffers as being available to receive the given stage or not available to receive the given stage. If there is specific memory buffers available in decision block 612, then one proceeds with writing (616) the given stage to the specific memory buffers when the specific memory buffers are available; storing (618) the given segment on the consumer device; and removing (620) the given segment from the specific memory buffers and freeing the specific memory buffers for a next stage to be processed in steps 604, 606, 608, 610, 616, 618, and 620. This involves employing decision block 612 to determine whether one should or needs to access a next or another segment of the multiple media data segments from the producer device. In block 614, a next or another segment of multiple media data segments from the producer device is accessed or the producer's device waits until a buffer becomes available at the consumer side to process the next segment. If all segments have not been stored per decision box 620, then a re-accessment and re-verification of the segments that may have previously failed the verification stage is performed.

The foregoing illustrates only some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents

What is claimed is:

1. A method of accessing and storing multiple media data segments from a producing device on to a consumer device comprising;
allocating a portion of memory buffer on a consumer device for receiving the multiple media data segments, wherein the allocation of the portion is performed responsive to the nature of the multiple media data segments;
accessing a first segment of the multiple media data segments for writing;
verifying a status of the portion of memory buffer as being available to receive the first segment or not being available to receive the first segment;
writing the first segment to the portion when the portion is available;
storing the first segment on the consumer device,
removing the first segment from the portion; and
repeating the allocating, accessing, verifying, writing, and storing steps for other segments, one by one.

2. The method of claim 1, wherein the multiple media segments are read from a file reader.

3. The method of claim 1, wherein the multiple media segments are MP4, AV1 or MP3 multimedia file formats.

4. The method of claim 1 comprising receiving the multiple media data segments by the consumer device employing a network protocol.

5. The method of claim 1 comprising creating the portion of the memory buffer from a memory pool of graphics card internal memory.

6. The method of claim 1 comprising the step of the consumer device communicating input data rate required by the consumer device to receive the multimedia data segments.

7. The method of claim 1 comprising the step of limiting the portion of memory buffer such that the portion has a fixed size that is limited to a necessary and sufficient quantity, thereby other portions of the memory buffer are free for other applications.

8. A method that involves a system in which at least one producing device provides multiple media data segments to a consumer device, the method comprises:
a) allocating specific memory buffers on the consumer device for receiving the multiple media data segments, wherein the allocation of the specific memory buffers is performed responsive to the nature of multiple media data segments;
b) accessing a first segment of the multiple media data segments for writing;
c) verifying a status of the specific memory buffers as being available to receive the first segment or not available to receive the first segment;
d) writing the first segment to the specific memory buffers when the specific memory buffers are available;
e) storing the first segment on the consumer device; and
f) repeating steps a through e for other segments, one by one.

9. The method of claim 8 comprising the step of limiting the specific memory buffers to fixed sizes which are sufficient to permit other portions of memory on the consumer device to be free for other applications.

10. The method of claim 8, wherein the storing step further comprises removing the first segment from the portion.

11. A method of accessing and storing multiple stages of media data from a producing device on to a consumer device comprising:
accessing a header for each of the stages;
allocating specific memory buffers on the consumer device for receiving the multiple stages data, wherein the specific memory buffers have a fixed size that is large enough to store all the headers and a user provided payload buffer;
separately accessing each stage for writing;
verifying a status of the specific memory buffers as being available to receive the given stage or not available to receive the given stage;
writing the given stage to the specific memory buffers when the specific memory buffers are available; and
storing the given segment on the consumer device; and
removing the given segment from the specific memory buffers and freeing the specific memory buffers for a next stage to be processed in the verifying, writing and storing steps.

12. The method of claim 11, wherein the specific memory buffers are limited to a necessary and sufficient quantity or quantities such that other portions of memory on the consuming device are free for other applications.

13. The method of claim 11 comprising creating the specific memory buffers from a memory pool of graphics card internal memory.

14. The method of claim 11 comprising creating the specific memory buffers according to stacked network protocols.

15. The method of claim 11 comprising creating the specific memory buffers according to stacked network protocols, wherein each protocol implemented as a stage requires adding its own header to the memory block containing user provided payload.

16. The method of claim 11 comprising writing the headers.

17. The method of claim 11, comprising creating the specific memory buffers according to stacked network protocols, wherein each protocol implemented as a stage requires adding its own header to the memory block containing user provided payload and wherein at least one stage uses an RTP protocol and an RTP protocol header is added in front of at least one user provided payload.

18. The method of claim 11, wherein multiple producers are accessed and the consumer device permits the producers to just fill in their header portion.
